(19) United States
(12) Patent Application Publication
(10) Pub. No.: US 2002/0073306 A1
(43) Pub. Date: Jun. 13, 2002

(54) System and method for protecting information stored on a computer

(76) Inventors: Gaspare Aluzzo, Annapolls, MD (US); William Bigno, Woodbridge, VA (US)

Correspondence Address: Finnegan, Henderson, Farabow,, Garrett & Dunner, L.L.P., 1300 I Street, N.W., Washington, DC, 20005-3315, US

(21) Appl. No.: 09/950,527

(22) Filed: Sep. 10, 2001

Related U.S. Application Data
(60) Provisional application No. 60/231,334, filed on Sep. 8, 2000.

(51) Int. Cl. G06F 9/00

(52) U.S. Cl. 713/1

(57) ABSTRACT

An embodiment of the invention is a method for protecting information processed, transmitted, or stored on a computer having a bootup operation, an operating system, at least one input device, and at least one output device. The computer checks for a first authentication during the bootup operation of the computer, the first authentication being associated with an external device connected to the computer. At least one input device of the computer is locked if no first authentication is present during the bootup operation of the computer. The computer may check for a second authentication when the operating system is operational and lock the at least one input device if no second authentication is present while the operating system is operational. Checking for an authenticated token as an authentication may comprise querying at a Smart Card reader for an authorized Smart Card.

### RELATED APPLICATIONS

This application claims the benefit of priority from Provisional U.S. Patent Application Ser. No. 60/231,334, entitled “SYSTEM AND METHOD OF PROTECTING INFORMATION STORED ON A COMPUTER,” filed on Sep. 8, 2000, by the same inventors, which is expressly incorporated herein by reference.

Additionally, this application is related to commonly owned U.S. patent application Ser. No. ______, entitled “SYSTEMS AND METHODS FOR PROTECTING INFORMATION ON A COMPUTER BY INTEGRATING BUILDING SECURITY AND COMPUTER SECURITY FUNCTIONS,” filed on the same date herewith by the same inventors.

### BACKGROUND OF THE INVENTION

1. Field of the Invention

The present invention relates to computer security, and, more particularly, to the use of an authenticating device, such as a token, to secure a computer and its memory components from improper access.

2. Background and Material Information

Because government and business entities are storing a wealth of sensitive information on computers, the protection of information has never been more important. Systems which safeguard data from espionage and theft have been developed to address this problem.

On the level of personal computers, traditional systems often implement this protection via the use of passwords. Nonetheless, passwords for computer systems often fail their objective because they operate at the operating system (OS) level. An OS is a main control program for a computer that schedules tasks, manages storage, and handles communication with peripherals. The OS presents a basic user interface when no applications are open, and all applications must communicate with the operating system, thus allowing input from a user and output from application programs. A user desiring to bypass a password at the OS level often needs only to reboot the computer and/or operate the computer in a “Safe Mode” to avoid the OS level password protection. A Safe Mode is a special mode of the OS that loads with minimal driver support. The intended purpose of the Safe Mode is to help resolve boot problems, but its lack of security capability leaves open the possibility of unauthorized access to sensitive and/or proprietary information.

Still other systems utilize a physical key to be used each time a computer is utilized. In these systems, the key is tied to the power supply of the computer so as to disable the power supply when the key is not present. Nonetheless, implementations of physical keys do not provide protection after a bootup sequence without requiring the computer to be powered down. “Bootup” refers to the process of loading the OS into the dynamic memory of the computer. For example, when a user leaves the user's computer terminal during the day while the computer is running, the user must either leave the computer running with the key present or power the computer down and remove the key. As such, it would simply be impracticable to turn the computer off and remove the key every time the user leaves the computer, since a lengthy reboot operation would be required each time the user returned and replaced the key. More often than not, a computer user under this security regime would simply leave the computer running and would not remove the key during breaks, thus exposing the computer data to possible thievery.

Moreover, traditional systems such as passwords or physical keys offer no protection against the physical removal and theft of a computer hard drive. When a thief takes a hard drive in this way, the thief often need only operate the hard drive as a “slave” to another computer to download and access all the information on the stolen hard drive.

What is needed is a security system that allows for the protection of computer data or information upon bootup (e.g., during the execution of the basic input/basic output (BIOS) instructions) and during the ongoing operation of the computer (e.g., during the execution of the OS). Those skilled in the art will appreciate that BIOS instructions, which provide the initial processing instructions to the computer, are typically resident in the motherboard of a computer but can be stored elsewhere according to the particular computer architecture implementation.

What is also needed is a system which provides effective security measures that allow for computer users to take breaks away from the computer without powering the computer down to activate the security upon leaving. Correspondingly, such security measures should not require a bootup operation to deactivate the security upon returning. Finally, this system should afford protection against the theft of computer data or information even when a hard drive or other computer-readable memory is physically removed from the computer and manipulated by another computer.

### SUMMARY OF THE INVENTION

Methods, systems, and computer-readable media consistent with the present invention overcome these problems and provide enhanced security measures. In one aspect, a method consistent with an embodiment of the invention is disclosed for protecting information processed, transmitted, or stored on a computer having a bootup operation, an operating system, at least one input device, and at least one output device. The computer checks for a first authentication during the bootup operation of the computer, the first authentication being associated with an external device connected to the computer. At least one input device of the computer is locked if no first authentication is present during the bootup operation of the computer. The computer may check for a second authentication when the operating system is operational and lock the at least one input device if no second authentication is present while the operating system is operational.

In another aspect of the present invention, a system consistent with an embodiment of the invention is described for protecting information in a computer having a memory and at least one input device. The system comprises at least one token, a reader for reading the at least one token, and a first software operational in the memory for disabling the at least one input device of the computer during a bootup operation if the at least one token is not read by the reader. The system may also comprise a second software operational in the memory for disabling the at least zone input device of the computer when an operating system is operational if the at least one token is not read by the reader.

Moreover, the system may comprise a third software operational in the memory for disabling at least one output device of the computer when an operating system is operational if the at least one token is not read by the reader. Finally, the system may comprise a fourth software operational in the memory for placing the memory in an inaccessible state if the at least one token is not read by the reader when the computer attempts to access the memory.

Additional advantages of the invention will be set forth in part in the description which follows, and in part will be obvious from the description, or may be learned by practice of the invention. The advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate several embodiments of the invention and together with the description, serve to explain the principles of the invention.

Reference will now be made in detail to the present embodiments of the invention, examples of which are illustrated in the accompanying drawings. Wherever possible, the same reference numbers will be used throughout the drawings to refer to the same or like parts.

In the drawings:

FIG. 1 is a diagram of an exemplary system environment in which to practice an embodiment of the present invention;

FIG. 2 is a flowchart of an exemplary method in accordance with an embodiment of the present invention;

FIG. 3 is a flowchart of an exemplary subroutine in accordance with an embodiment of the present invention;

FIG. 4 is a flowchart of another exemplary subroutine in accordance with an embodiment of the present invention;

FIG. 5 is a flowchart of yet another exemplary subroutine in accordance with an embodiment of the present invention;

FIG. 6 is a flowchart of an exemplary method for utilizing public key infrastructure (PKI) in accordance with an embodiment of the present invention; and

FIG. 7 illustrates a flowchart of an exemplary method for checking to determine whether a user is authenticated to access files in static memory consistent with an embodiment of the present invention.

### DESCRIPTION OF THE EMBODIMENTS

Embodiments of the present invention provide for a system which protects information stored within or as part of a computer by requiring an authentication in order for a user to access the information. The authentication is associated with an external device connected to the computer. For example, the external device may comprise a token reader, such as a Smart Card reader, which reads tokens provided by one or more authorized users. Further, software is loaded into the memory of the computer which provides protection at both the Basic Input/Output System (BIOS) level and at the OS level. Coding resident in the memory of the computer provides another means of protection. This coding ensures that the memory, e.g., the hard drive, cannot be removed from the computer and used as a slave to another computer.

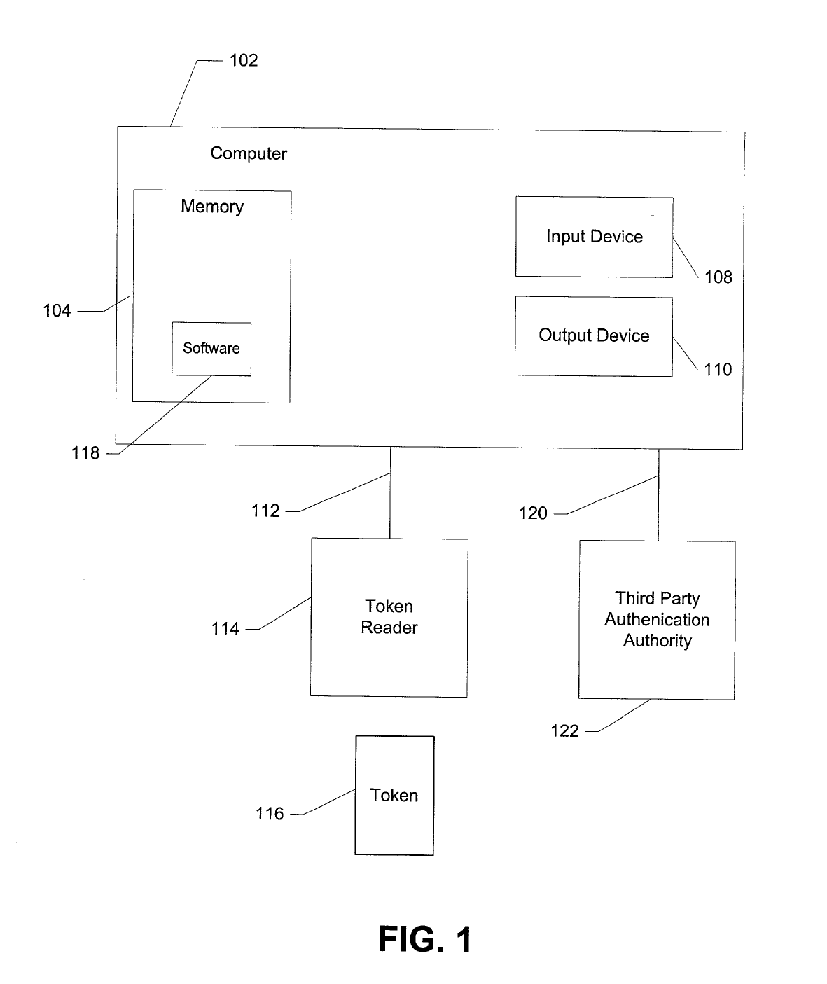

Referring to FIG. 1, an exemplary system environment is illustrated in which to practice an embodiment of the present invention. In this exemplary embodiment, a computer 102 includes a memory 104, at least one input device 108, and at least one output device 110. Input device 108 may comprise, by way of example but not of limitation, a mouse, a keyboard, a microphone, a joystick, a trackball, a touch screen reader, a scanner, and the like. Output device 110 may comprise, by way of example but not of limitation, a printer, a plotter, a monitor, a speaker, and the like.

Computer 102 is operatively connected to a token reader 114 by link 112. One skilled in the art will recognize that the connection may include a port or communication interface (not shown) comprising, among other things, switches. Nevertheless, the present invention contemplates any suitable implementation of a communication interface. A token 116 is to be used with reader 114 for providing authenticated access to computer 102. Token reader 114 may comprise, for example, a Smart Card reader, a radio frequency (RF) tag reader, a magnetic stripe reader, a retinal scanner, a fingerprint reader, a palmprint reader, and the like. Correspondingly, token 116 may comprise, for example, a Smart Card, an RF tag, a token having a magnetic stripe, or the retina, fingerprint, or palmprint from a user (not shown). Generally, token 116 stores (by design or merely by coincidence) the encoded authenticating information for the user.

When token 116 is placed in contact with, in proximity of, or in operative engagement with token reader 114, token reader 114 verifies authenticating information encoded in or on token 116. This authenticating information is then sent to computer 102 via link 112 and a communication interface (not shown) of computer 102.

In the exemplary embodiment, token reader 114 may secure and retain token 116 during the process of authenticating a token 116 described above. Furthermore, token reader 114 may secure and retain token 116 during the usage of computer 102 after token 116 is authenticated. In this way, when token 114 is removed from token reader 114, computer 102 may check for authenticity and disallow further use of the input device 108, the output device 110, and/or any other computer functionality. Token 116 may also be fixably attached to the user or the user's person, such that when the user leaves the computer terminal, token 116 is removed from token reader 114. In this way, authenticated access to the input device 108, the output device 110, and/or any other computer functionality will be given only when token 116 is present in token reader 114.

Thus, software 118 operational in memory 104 may disable at least none input device 108 during a bootup operation if an authenticated token 116 is not present in reader 114. Alternately, software 118 operational in memory 104 may disable at least one output device 110 during a bootup operation if authenticated Smart Card 116 is not present in reader 114. Moreover, at least one input device (such as input device 108) and/or at least one output device (such as output device 110) may be disabled when an authenticated Smart Card 116 is not present in reader 114 while the OS is operational in memory 104.

In an exemplary embodiment utilizing public key infrastructure (PKI) for encryption and/or decryption of data, computer 102 sends authenticating information to a third party certification authority 122 via link 120. Third party certification authority 122 may then send an electronic permission indicator back to computer 102 via link 120. Third party certification authority 122 may comprise any a trusted third party responsible for issuing authentications, such as Entrust, VeriSign, Baltimore Technologies, and RSA Security, for example. When computer 102 receives the electronic permission indicator, computer 102 is then authorized to either encrypt or decrypt data.

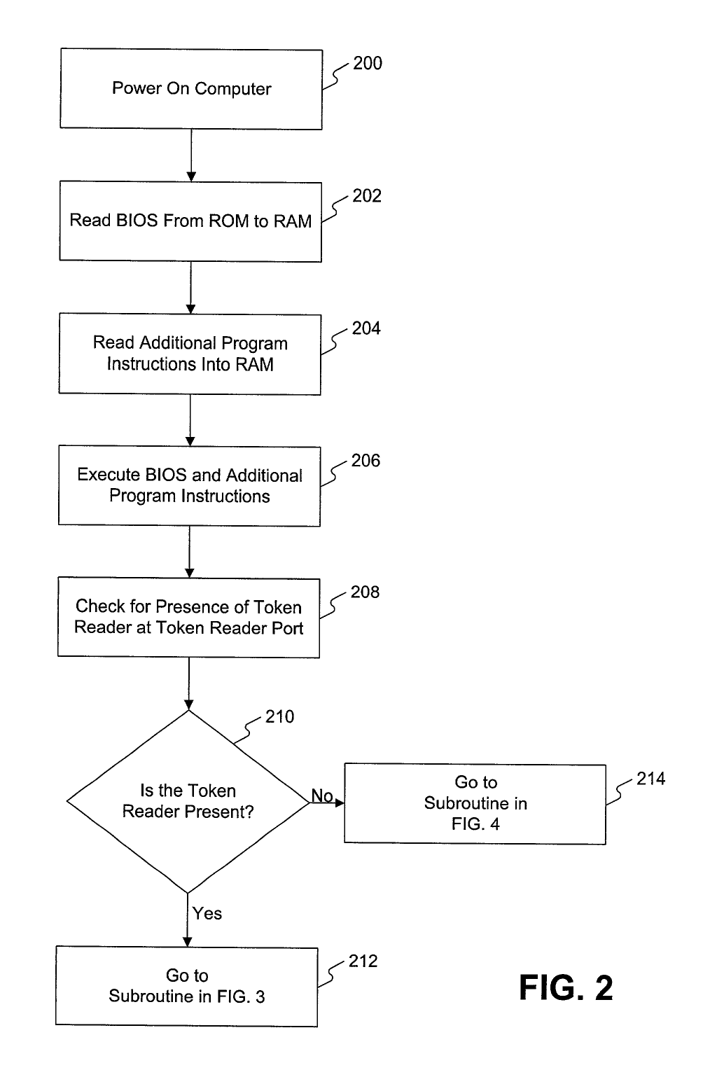

Turning to FIG. 2, an exemplary method in accordance with an embodiment of the present invention will be illustrated. In step 200, a computer is powered on or otherwise booted. BIOS instructions are read from read-only memory (ROM) to random access memory (RAM) in step 202. Along with these BIOS instructions, additional program instructions are read into RAM relating to token reader 114 (step 204). These extra instructions may be read into RAM immediately after BIOS instructions are read into RAM. Thus, instructions for both the BIOS and Smart Card system are executed substantially coincidentally, as shown in step 206.

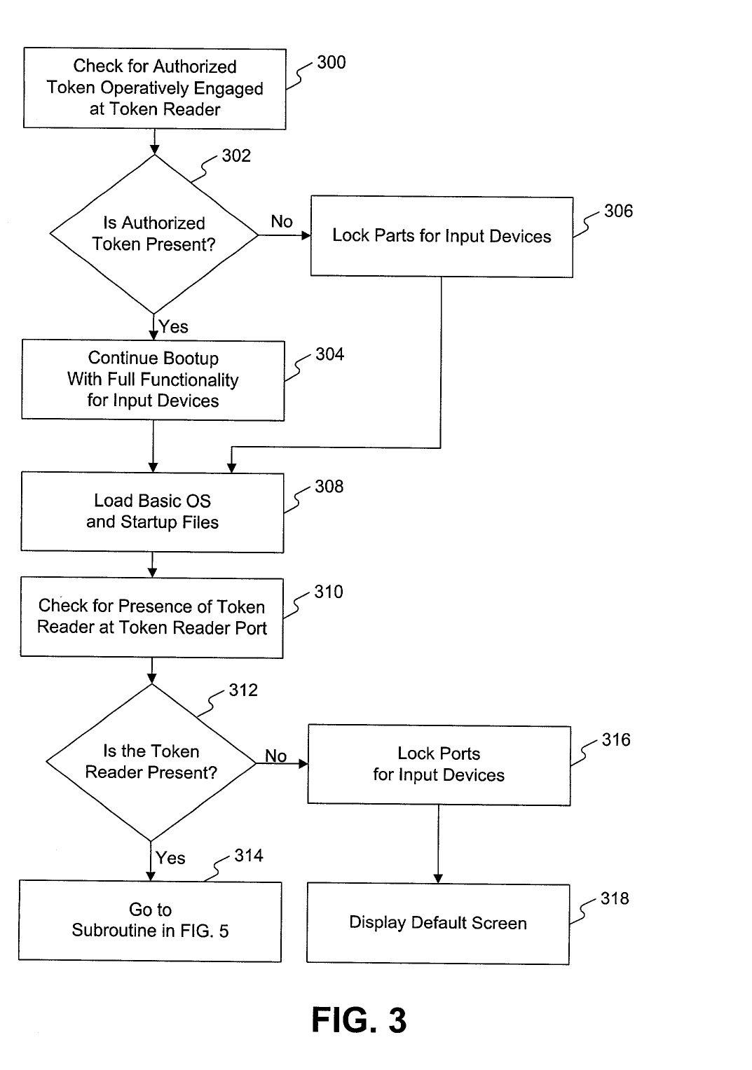

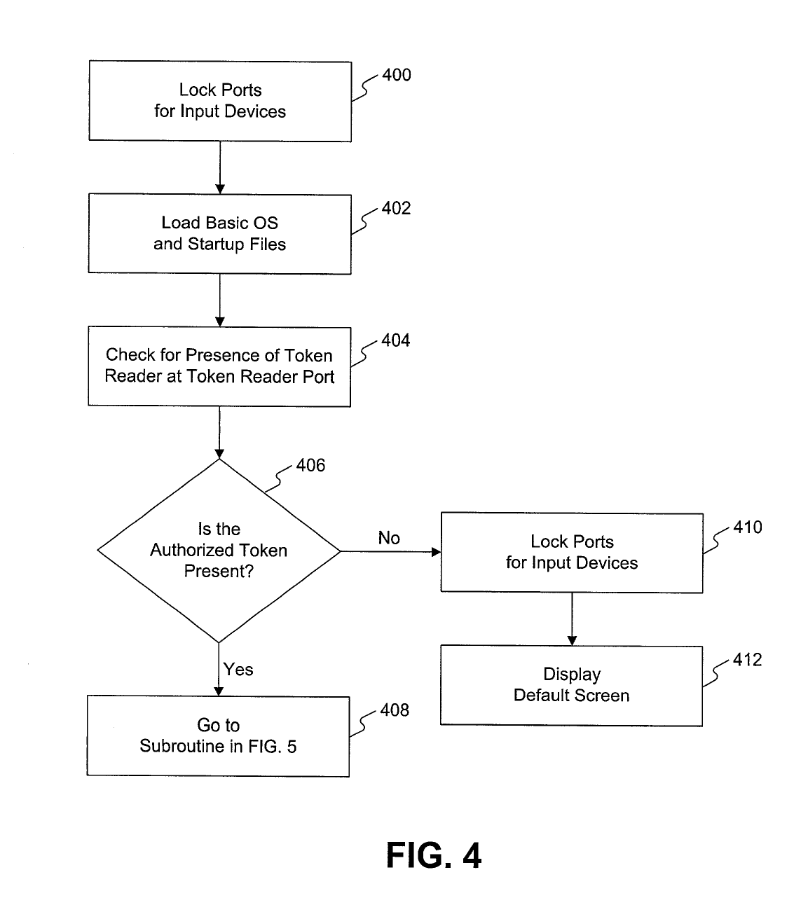

When these instructions are executed, the computer performs a check to see if a token reader is present (step 208). A determination is made in step 210 whether a token reader is present. If the reader is present, the method advances to the subroutine of FIG. 3 described below (step 212). If the reader is not present, the method advances to the subroutine of FIG. 4 described below (step 214).

An exemplary subroutine in accordance with an embodiment of the present invention will now be described with reference to FIG. 3. This exemplary subroutine is typically performed only if a token reader is present in step 212 of FIG. 2. At step 300, a check is performed to determine if an authenticated token is operatively engaged at token reader 114. In step 302, a determination is made whether an authenticated token is present at the token reader 114. If an authenticated token is present, the subroutine advances to step 304. Normal bootup is continued in step 304 with full functionality for the at least one input device 108. If an authenticated token is not present, however, the subroutine advances to step 306, where a port or other type of communication interface corresponding to the at least one input device 108 is locked.

The port may be locked via an instruction (e.g., a binary instruction) implemented in software which may, for example, engage a switch. By engaging the switch, all signals coming from the at least one input device are interrupted, effectively locking the at least one input device. Step 306 serves to disable the at least one input device 108 so that a would-be thief (more generally referred to as a potential user) would be thwarted in using the input devices of the computer to circumvent security measures. Thus, the computer is locked at the BIOS level (i.e., before the OS is operational) because a user cannot manipulate the computer even when the BIOS is operational. In addition, in the case where an unauthenticated token has been presented at token reader 114, step 306 may further comprise detaining the unauthenticated token in the computer access token reader 114.

In step 308, conventional OS files and startup files are loaded from ROM or from static memory to RAM, and these files are executed in a normal fashion. For example, in a Microsoft DOS operating system, CONFIG.SYS, AUTOEXEC.BAT, and other various OS files are typically processed at this step. Those skilled in the art will be familiar with the bootup process for the Microsoft DOS operating system as well as for other computer systems.

The method advances to step 310, where a check is performed to determine if an authenticated token is operatively engaged at token reader 114. The purpose of this check is to determine whether a reader may have been connected by a would-be thief, only to be removed once the BIOS security checks have been surpassed. In contrast to the previous check, which operated at the BIOS level, this check provides a measure of protection at the OS level. In step 312, a determination is made whether the token reader is still present to the computer system. If a token reader is not present at this check, the method advances to step 316, where the at least one input device 108 is locked. In the exemplary embodiment, locking of the at least one input device 108 is accomplished in the same manner described above: A binary instruction engages a switch, thereby interrupting signals from the at least one input device.

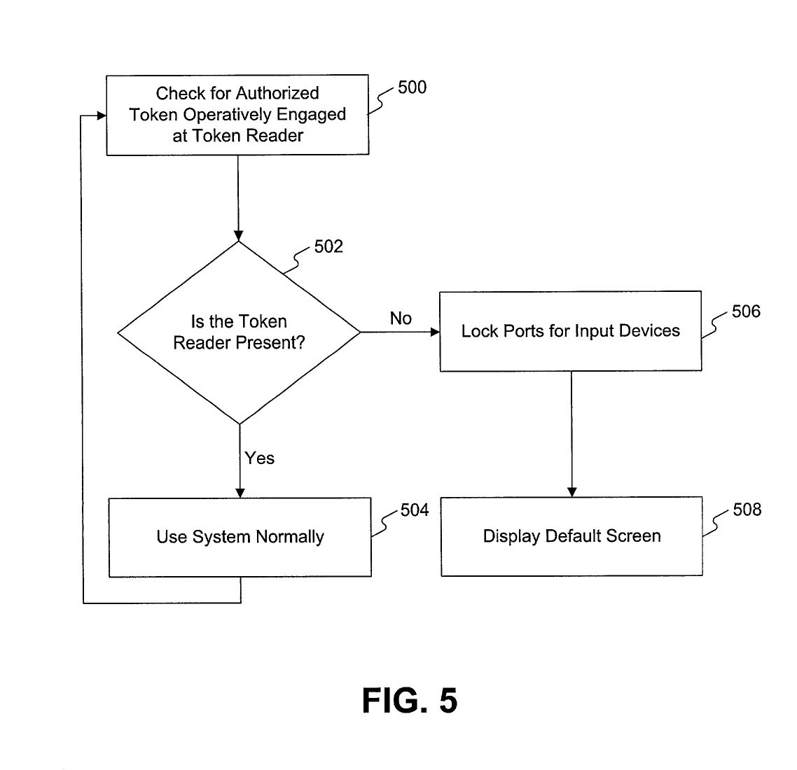

Step 316 effectively disallows the user from manipulating computer functions in any way. Further, in step 318, a default screen is displayed which overrides normal computer displays. This default screen may comprise, for example, a monochromatic screen display or a default message display (e.g., “Computer Locked”). Optionally, the monitor may be powered down by the computer, revealing a blank screen. If a token reader is present at step 312, the method advances to the subroutine shown in FIG. 5, as described below (step 314).

Now with reference to FIG. 4, an exemplary subroutine according to an embodiment of the present invention will be described. The exemplary subroutine of FIG. 4 corresponds to the situation where a token reader is not present at the first check. In step 400, ports corresponding to the at least one input device 108 are locked, thus preventing a computer user from manipulating computer function in any way. In step 402, conventional OS files and startup files are loaded from ROM or from static memory to RAM, and these files are executed in a normal fashion. The method advances to step 404, where a check is performed for the presence of the token reader at the token reader port. The purpose of this check is to determine whether a reader may have been connected by a would-be thief, only to be removed once the BIOS security checks have been surpassed.

In step 406, a determination is made whether the token reader is still a present to the computer system. If a token reader is not present at this check, the method advances to step 410, where the input devices are locked. Further, in step 412, a default screen is displayed which overrides normal computer displays. If a token reader is present at step 406, the method advances to the subroutine shown in FIG. 5, as described below (step 408).

FIG. 5 illustrates a flowchart of a subroutine in accordance with the present invention. In step 500, a check is performed to determine whether an authenticated token is operatively engaged at the token reader. In step 502, a determination is made whether an authenticated token is present at the token reader 114. If an authenticated token is not present at this check, the method advances to step 506, where the input devices are locked and step 508, where a default screen is displayed, the default screen typically overriding normal computer displays. If an authenticated token is present at step 502, normal computer function is available (step 504).

Once a user has access to full computer functionality, the computer may perform an ongoing check that the authenticated token is still present. This is represented by the loop back from step 504 to step 500 in FIG. 5. In this way, when an authenticated user removes an authenticated token from the token reader 114, the ongoing check will cause the computer to immediately engage the locking feature of step 504 and the default screen of step 508.

In practice, embodiments of the present invention allow a user to boot a computer even when an authenticated token is not present. In this situation, however, the input devices are locked during bootup, so as to thwart an unauthorized user's attempt to override the bootup and to place the computer in a “Safe Mode,” for example. Therefore, the computer cannot be manipulated by an unauthorized user during the bootup sequence. Correspondingly, authenticated users may boot their computers without waiting for an authenticated token to be present. Thus, authenticated users need not later wait through the bootup sequence if they neglect to place their authenticated token in the reader at startup.

The OS-level check for an authenticated token allows an authenticated user to alternate between locked and unlocked modes at the OS level. The lock is activated simply by removing the token. For example, if a user temporarily leaves the computer and takes the authenticated token from the reader, the computer reverts to its locked mode. When the user returns and replaces the authenticated token in the reader, full functionality is restored.

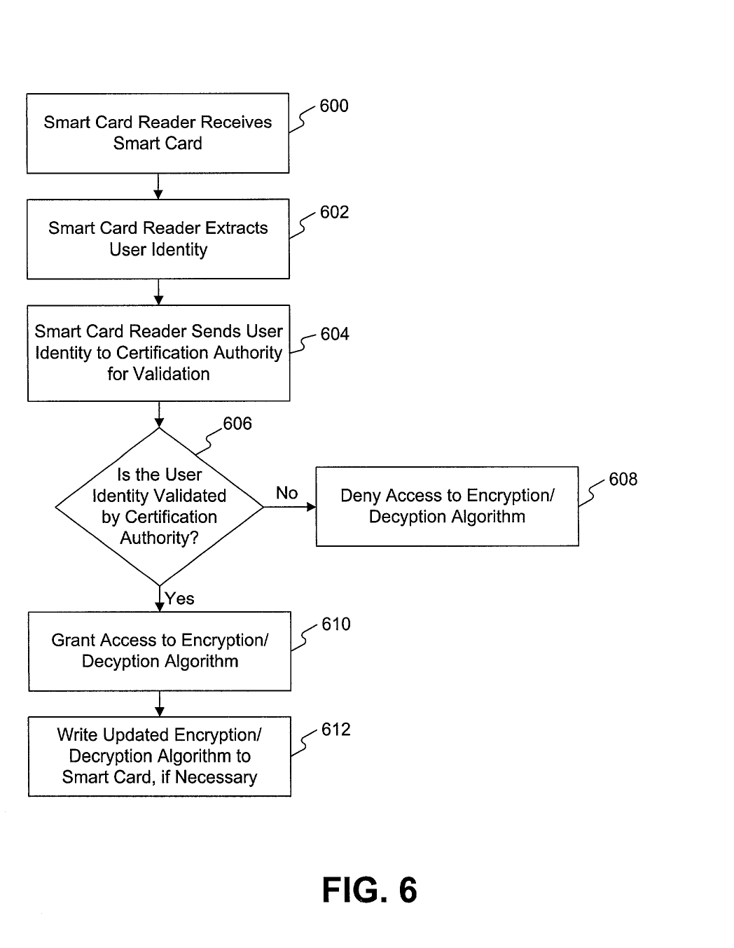

Now with reference to FIG. 6, the exemplary method for authenticating a user (as described above) may be integrated with a public key encryption scheme (i.e., PKI) for encryption and/or decryption of data. Moreover, the token the user presents for authentication may be utilized in the PKI system for storing a user identity and public and/or private encryption keys. While the method of FIG. 6 will be described utilizing a Smart Card for the token, those skilled in the art will appreciate that any type of token, besides the specific example of a Smart Card, is contemplated by the principles of the present invention.

Turning to FIG. 6, a Smart Card reader receives a Smart Card in step 600. The reader extracts a user identity from the Smart Card in step 602 and sends the user identity to third party certification authority 122 for validation in step 604. A determination is made whether the user identity is validated at third party certification authority 122 in step 606. Step 606 serves to verify the identity of the user presenting the Smart Card. If user identity is not verified in step 606 (“No”), then the potential user is denied access to the PKI application, as shown in step 608. If the user identity is verified in step 606 (“Yes”), user is authorized to access the PKI application in step 610.

As is known in the art, the user's public and private keys are periodically changed pursuant to the PKI process. A change interval for updating the public and private keys may be determined by a PKI administrator at third party certification authority 122. If a user is authorized to access the PKI encryption/decryption algorithm in step 610, and if the change interval has expired, updated public and/or private keys may be written to the Smart Card in step 612.

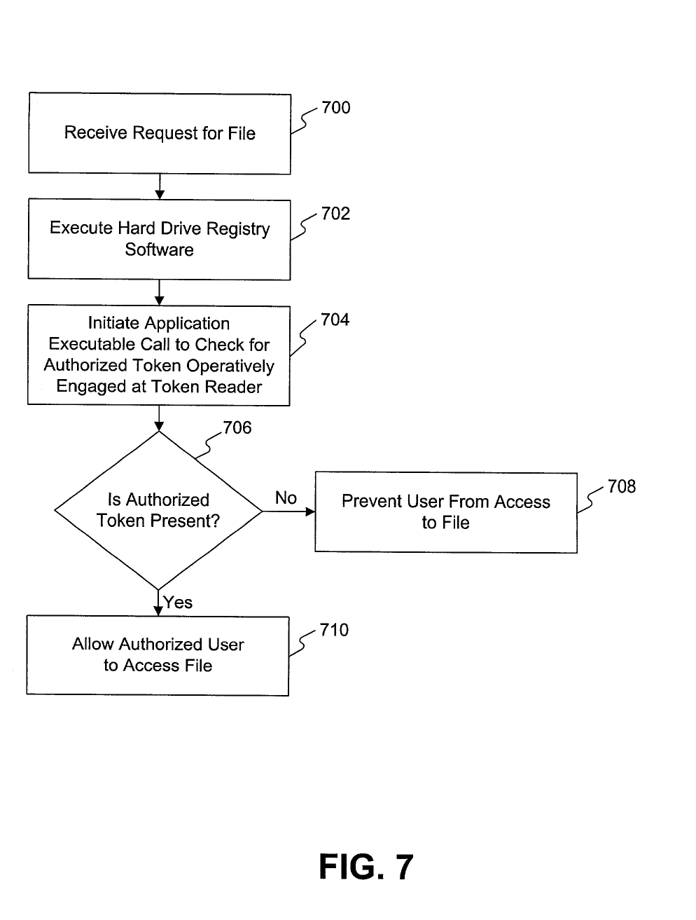

FIG. 7 illustrates a flowchart of an exemplary method for checking to determine whether a user is authenticated to access files in static memory, such as the hard drive, consistent with an embodiment of the present invention. As mentioned previously, coding resident in the hard drive ensures that only authorized users have access privileges to certain files. Access privileges define the extent to which a user may access a file to, for example, view, modify, or create its contents. The access privileges for files on the hard drive are defaulted to a protected or inaccessible state. One skilled in the art may exclude some system files from this default inaccessible state so as to allow access to such files.

At step 700, the computer receives a request to access a file from a user or from a program which the user is operating. In the exemplary embodiment, a software module, referred to as hard drive registry software, is then executed in step 702. As is known in the art, a “registry” is a repository for all the miscellaneous settings such as, for example, how computer memory is set up and what application programs are to be present when the OS is started. “Registry software” refers to software capable of implementing those settings. Substantially coincidental with the execution of the hard drive registry software, application executable call checks to determine whether an authenticated token is operatively engaged at token reader 114 (step 704). As a result of this application executable call, a determination is made whether an authenticated token is present at the token reader 114 in step 706. If the user is not authenticated to access the file, the access privileges are left unchanged, leaving the file inaccessible (step 708). If the user is authenticated to use the file, the access privileges for the file are changed from the default (ie., inaccessible) to an accessible state, as shown in step 710. Thus, the exemplary method of FIG. 7 prevents an unauthorized user from accessing the protected files.

An aspect of the exemplary method of FIG. 7 is that the method may protect memory 104 even if it is physically removed from the computer. For example, if a hard drive is physically removed from a computer, an unauthorized user cannot install the hard drive on another computer and access the data thereon. Similarly, if a hard drive is physically removed from a computer, an unauthorized user cannot install the hard drive as a “slave” to another computer and access the data thereon. Thus, access to memory 104 is only available when an authenticated token is placed in token reader 116.

Other embodiments of the invention will be apparent to those skilled in the art from consideration of the specification and practice of the invention disclosed herein. Those skilled in the art will appreciate that the principles of the present invention may be implemented in a variety of ways, such as with hardware, software, or in a combination. Programs or resident code used to implement such embodiments of the present invention may be stored on computer-readable medium, such as RAM, ROM, removable hard drives, or any other memory storage device. Therefore, it is intended that the specification and examples be considered as exemplary only, with a true scope and spirit of the invention being indicated by the following claims.

What is claimed is:

1. A method for protecting information stored on a computer having a bootup operation, an operating system, at least one input device, and at least one output device, comprising:
checking for a first authentication during the bootup operation of the computer, the first authentication being associated with an external device connected to the computer; and
locking the at least one input device of the computer if no first authentication is present during the bootup operation of the computer.

2. The method of claim 1, wherein checking for the first authentication further comprises checking for a first token.

3. The method of claim 2, wherein checking for the first token further comprises querying at least one of a Smart Card reader, a radio frequency (RF) tag reader, a magnetic stripe reader, a retinal scanner, a fingerprint reader, and a palmprint reader regarding the presence of the first authenticated token.

4. The method of claim 3, wherein the first token comprises at least one of a Smart Card, an RF tag, a token having a magnetic stripe, a retina from a user, a fingerprint from the user, and a palmprint from the user.

5. The method of claim 1, wherein checking for the first authentication further comprises checking for a first password.

6. The method of claim 1, further comprising:
checking for a second authentication when the operating system is operational; and
locking the at least one input device if no second authentication is present while the operating system is operational.

7. The method of claim 6, wherein checking for the second authentication further comprises checking for a second token.

8. The method of claim 7, wherein checking for the second token further comprises querying at least one of a Smart Card reader, a radio frequency (RF) tag reader, a magnetic stripe reader, a retinal scanner, a fingerprint reader, and a palmprint reader regarding the presence of the second token.

9. The method of claim 8, wherein the second token comprises at least one of a Smart Card, an RF tag, a token having a magnetic stripe, a retina from a user, a fingerprint from the user, and a palmprint from the user.

10. The method of claim 6, wherein checking for the second authentication further comprises checking for a second password.

11. The method of claim 9, wherein the first token and the second token are the same.

12. The method of claim 6, further comprising:
continuing the bootup operation even if the at least one input device is locked.

13. The method of claim 1, wherein the external device comprises a token reader.

14. The method of claim 1, further comprising locking the at least one output device.

15. The method of claim 6, further comprising locking the at least one output device.

16. A system for protecting information stored on a computer having a bootup operation and an operating system, comprising:
at least one input device;
an external device connected to the computer;
a checking module for checking for an authentication during the bootup operation of the computer, the authentication being associated with the external device; and
a locking module for locking the at least one input device of the computer if no authentication is present during the bootup operation of the computer.

17. The system of claim 16, wherein the checking module further comprises software instructions operational on the computer.

18. The system of claim 16, wherein the locking module comprises an instruction which locks a communication interface in the computer that connects the external device.

19. The system of claim 18, wherein the instruction engages a switch at the interface.

20. The method of claim 16, wherein the external device comprises at least one of a Smart Card reader, a radio frequency (RF) tag reader, a magnetic stripe reader, a retinal scanner, a fingerprint reader, and a palmprint reader regarding the presence of the authentication.

21. The system of claim 20, further comprising:
at least one output device, wherein the locking module locks the at least one output device of the computer if no authentication is present during the bootup operation of the computer.

22. A system for protecting information in a computer having a memory and at least one input device, the system comprising:
at least one token;
a reader for reading the at least one token; and
a first software operational in the memory for disabling the at least one input device of the computer during a bootup operation if the at least one token is not read by the reader.

23. The system of claim 22, further comprising:
a second software operational in the memory for disabling the at least one input device of the computer when an operating system is operational if the at least one token is not read by the reader.

24. The system of claim 22, further comprising:
a third software operational in the memory for disabling at least one output device of the computer when an operating system is operational if the at least one token is not read by the reader.

25. The system of claim 22, further comprising:
a fourth software operational in the memory for placing the memory in an inaccessible state if the authorized token is not read by the reader when the computer attempts to access the memory.

26. The system of claim 25, wherein the memory further comprises registry software; and wherein the fourth software further comprises an application executable call executed substantially coincidentally with the registry software.

27. The system of claim 25, wherein the memory defaults to an inaccessible state.

28. The system of claim 27, wherein the memory changes to an accessible state if the authorized token is read by the reader.

29. A computer-readable medium operative in a computer system having a bootup operation, at least one input device, a token reader, and at least one authenticated token, the computer-readable medium containing a program for protecting information within the computer system by carrying out steps comprising:
checking for an authenticated token in the token reader during the bootup operation of the computer system; and
locking at least one input device if an authenticated token is not read by the token reader.

30. The computer-readable medium of claim 29, wherein the computer system comprises at least one output device; and
wherein the program further comprises locking the at least one output device if the authenticated token is not read by the token reader.

31. The computer-readable medium of claim 29, wherein the program further comprises:
checking for the authenticated token in the token reader when the operating system is operational; and
locking at least one input device if the authenticated token is not read by the token reader.

32. The computer-readable medium of claim 31, wherein the computer system further comprises at least one output device, and wherein the program further comprises locking the at least one output device if the authenticated token is not read by the token reader.
